(19) United States
(12) Patent Application Publication
(10) Pub. No.: US 2010/0253235 A1
(43) Pub. Date: Oct. 7, 2010

(54) Non-flashing brightness adjusting device for non-resistive light-emitting load

(76) Inventor: Tsung-Ein Tsai, Taipei (TW)

Correspondence Address: COOPER & DUNHAM, LLP, 30 Rockefeller Plaza, 20th Floor, NEW YORK, NY, 10112, US

(21) Appl. No.: 12/454,088

(22) Filed: May 12, 2009

(30) Foreign Application Priority Data
Apr. 1, 2009 (TW) 098110830

(51) Int. Cl. H05B 41/36

(52) U.S. Cl. 315/241 R; 315/246; 315/283

(57) ABSTRACT

A non-flashing brightness adjusting device for a non-resistive light-emitting load has a brightness adjuster and a conductive current sustainer. The brightness adjuster has an AC silicon-controlled rectifier (SCR) and an adjustable trigger unit. By adjusting the adjustable trigger unit and setting a trigger angle of the TRIAC, a total output current of the brightness adjuster is adjusted. The conductive current sustainer is connected to the output terminal of the brightness adjuster for a non-resistive light-emitting load to connect. When the trigger angle of the TRIAC is greater than 90 degrees, the conductive current sustainer keeps the current flowing through the anode and cathode of the TRIAC not lower than its threshold current to maintain the conduction of the TRIAC. Therefore, the non-resistive light-emitting load keeps receiving the required working power and does not flash.

### BACKGROUND OF THE INVENTION

1. Field of the Invention

The invention relates to a brightness adjusting device and, in particular, to a non-flashing brightness adjusting device for a non-resistive light-emitting load.

2. Description of Related Art

With reference to FIG. 5, a household brightness adjuster is connected with a resistive lamp driving circuit. The brightness adjuster (50) has an AC silicon-controlled rectifier (SCR) (51) (TRIAC) and a trigger circuit (52).

The TRIAC (51) is connected in series to an AC power supply (AC/IN) and has an anode (T1), a cathode (T2) and a gate G The trigger circuit 52 is an RC phase-shifting circuit and comprises resistors (521) and capacitors (522). The node between the resistor (521) and the capacitor (522) is connected with the gate G of the TRIAC (51). The resistor (521) of the RC phase-shifting circuit is a variable resistor. By adjusting the resistance of the variable resistor, one determines the trigger angle of the TRIAC (51).

When the above-mentioned brightness adjuster (50) is connected to a resistive incandescent lamp (70), the TRIAC (51) will maintain in conductive state as long as the voltage of the power supply is nonzero, because the current will continue to flow between the anode (T1) and the cathode of the TRIAC through the resistive incandescent lamp (70). This controls the current and power of the resistive incandescent lamp (70), therefore its brightness. Consequently, the household resistive incandescent lamp (70) does not flash when it is used with the current brightness adjuster (50).

However, existing gas discharge lamps or illuminating light-emitting diodes (LED's) are non-resistive loads with threshold lightup voltages. They have to use an additional lamp driving circuit (60). With reference to FIG. 6, a lamp driving circuit (60) for a gas discharge lamp comprises a rectifier (61), a filter capacitor (62) and an inverter (63). The output terminal of the rectifier (61) is connected to the AC power supply (AC/IN) of the brightness adjuster (50) via the TRIAC (5 1). The AC power output from the TRIAC (5 1) is rectified into a DC sinusoidal wave, and then filtered by the filter capacitor (62) into a DC power. The inverter (63) converts the DC power into high-frequency AC power for activating the gas discharge lamp (64). No inverter is needed for the driving circuit of the LED. The DC power output from the filter capacitor can be used directly as the working power.

If the above-mentioned brightness adjuster is connected directly to the AC power supply (AC/IN) and the brightness adjuster outputs AC power with a trigger angle less than 90 degrees to the non-resistive light-emitting load, the filter capacitor will be charged around the peak voltage to the peak voltage value, and provide sufficient DC power to the next-stage power exchange devices.

On the other hand, if the brightness adjuster outputs AC power is reduced for the non-resistive light-emitting load with a trigger angle greater than 90 degrees, the filter capacitor has a voltage higher than the highest voltage of the input AC power. Therefore, input power is no longer supplied to the filter capacitor in this case. Current will stop flowing between the anode and the cathode of the TRIAC and thus the TRAIC is turned off. The lamp starts to flash because the DC power of the filter capacitor is insufficient.

Since the gas discharge lamp or illuminating LED has become popular and it is desirable to adjust their brightness, an improved technique is required to solve the flashing problem with such lamps.

### SUMMARY OF THE INVENTION

In view of the foregoing, an objective of the invention is to provide a non-flashing brightness adjusting device for a non-resistive light-emitting load, which uses a simple circuit design to solve the problem of flashing during brightness adjustments.

To achieve the above-mentioned objective, the non-flashing brightness adjusting device comprises a brightness adjuster and a conductive current sustainer. The brightness adjuster includes an TRIAC and an adjustable trigger unit. The adjustable trigger unit connects to the TRIAC to determine its trigger angle. The trigger angle is proportional to the total current output of the brightness adjuster. The conductive current sustainer connects to the output terminal of the brightness adjuster for a non-resistive light-emitting load. The current on the cathode and anode of the TRIAC is kept not lower than the threshold current, thereby maintaining the conduction of the TRIAC.

The output terminal of the brightness adjuster further connects to a conductive current sustainer that ensures the TRIAC is conducted even when the trigger angle of the TRIAC is greater than 90 degrees. Therefore, when a high power non-resistive light-emitting load is connected to an AC power supply via the non-flashing brightness adjusting device in accordance with the present invention, the filter capacitor of the rectifying filter circuit can receive a charging current from the input AC power supply even when the trigger angle is greater than 90 degrees. This solves the flashing problem of the brightness adjuster.

### BRIEF DESCRIPTION OF THE DRAWINGS

FIG. 1 is a circuit diagram of a first embodiment of the invention connected with a capacitive light-emitting load;

FIG. 2 is a circuit diagram of the first embodiment of the invention connected with an inductive light-emitting load;

FIG. 3 is a circuit diagram of the second embodiment of the invention connected with an inductive light-emitting load;

FIG. 4 is a circuit diagram of the second embodiment of the invention connected with a capacitive light-emitting load;

FIG. 5 is a circuit diagram of a conventional brightness adjuster connected with a resistive load; and

FIG. 6 is a circuit diagram of a conventional brightness adjuster connected with a non-resistive load.

### DETAILED DESCRIPTION OF THE PREFERRED EMBODIMENT

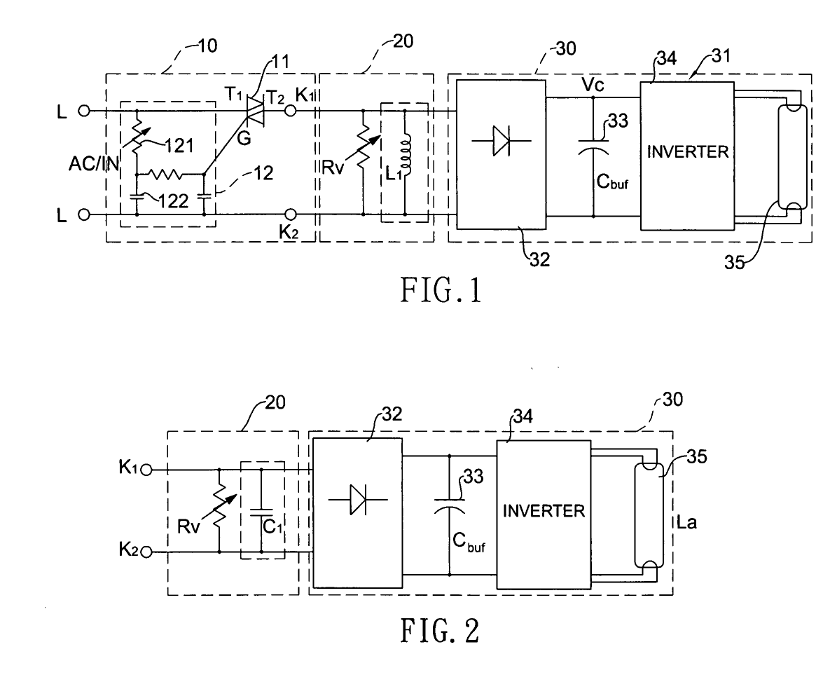

With reference to FIG. 1, a first embodiment of a non-flashing brightness adjuster in accordance with the present invention is connected to a non-resistive light-emitting load (30). The non-flashing brightness adjuster comprises a brightness adjuster (10) and a conductive current sustainer (20).

The brightness adjuster (10) has a TRIAC (11) and an adjustable trigger unit (12). The adjustable trigger unit (12) is connected to the TRIAC (11) to control the trigger angle of the TRIAC (11). The trigger angle is proportional to the total output current of the brightness adjuster (10). In this embodiment, the adjustable trigger unit (12) is an RC phase-shifting circuit comprising at least one variable resistor (121) connected in series with a capacitor (122). The TRIAC (11) has an anode (T1), a cathode (T2), and a gate (G). The gate (G) is connected to the node between the variable resistor (121) and the capacitor (122). The trigger angle of the TRIAC (11) is determined by adjusting the resistance of the variable resistor (121).

The conductive current sustainer (20) is connected to the output terminal of the brightness adjuster (10) and adapted to connect to the non-resistive light-emitting load (30). The conductive current sustainer (20) is also used to maintain the conduction of the TRIAC (11). In this embodiment, the conductive current sustainer (20) is a resistor. The conductive current sustainer (20) can also be a variable resistor or positive temperature coefficient resistor. When the AC power (AC/IN) outputs to the brightness adjuster (10) and the trigger angle of the brightness adjuster (10) is greater than 90 degrees, the current flowing through the anode (T I) and the cathode (T2) of the TRIAC (11) is kept not lower than its threshold current, since the conductive current sustainer (20) and the brightness adjuster (10) are connected in series to the AC power supply (AC/IN). If the positive temperature coefficient resistor is used, the resistance increases as the temperature of the brightness adjuster (10) rises after some time of use. Therefore, the voltage drop on the positive temperature coefficient resistor increases and the power supplied to the positive temperature coefficient resistor decreases and thereby lower its power dissipation.

In this embodiment, the non-resistive light-emitting load (30) comprises a driving circuit (31) and a fluorescent lamp (35).

The driving circuit (31) includes a rectifier (32), a filter capacitor (33), and an inverter (34). The rectifier (32) is connected to the conductive current sustainer (20), receives the AC power (AC/IN) with the trigger angle and rectifies the AC power into a DC sinusoidal wave. The filter capacitor (33) converts it into DC power V_{C}. The inverter (34) then converts the DC power V_{C} into high-frequency AC power for output. In this embodiment, the rectifier (32) can be a full-wave rectifier or voltage-double rectifier. The fluorescent lamp (35) connects to the output terminal of the inverter (34) to obtain the high-frequency AC power.

When the brightness adjuster (10) outputs AC power with a trigger angle less than 90 degrees to the non-resistive light-emitting load (30), the filter capacitor (33) of the driving circuit (31) will be charged to a peak voltage value when the AC power is at the highest voltage peak, providing sufficient DC power to next-stage devices.

If the brightness adjuster (10) outputs AC power with a trigger angle greater than 90 degrees to the non-resistive light-emitting load (30) is used, the conductive current sustainer (20) provides a current to the TRIAC (11) to ensure that the current flowing through the anode (T1) and the cathode (T2) of the TRIAC (11) is not lower than the threshold current so that the SCR (11) remains conductive. As a result, the AC power with a trigger angle greater than 90 degrees still continues to provide power to the next stage devices. When the filter capacitor voltage (V_{C}) of the driving circuit (31) is slightly lower than the highest peak voltage of the AC power with the trigger angle greater than 90 degrees, the filter capacitor (33) is immediately charged. The filter capacitor (33) therefore maintains the output of DC power to the inverter (34). Therefore, the invention ensures that the fluorescent lamp (35) does not flash while one adjusts the brightness.

The above-mentioned non-resistive light-emitting load (30) may be a capacitive load or an inductive load. To increase the power conversion efficiency of the brightness adjuster (10), the resistor (R_{V}) of the conductive current sustainer (20) can be further connected with a capacitor (C1) or an inductor (L1) in parallel. That is, when a capacitive light-emitting load (30) is connected to the brightness adjusting device of the present invention, the resistor (R_{V}) of the conductive current sustainer (20) is connected with an inductor (L1) in parallel. On the other hand, as shown in FIG. 2, when an inductive light-emitting load (30) is connected to the brightness adjusting device of the present invention, the resistor (R_{V}) of the conductive current sustainer (20) is connected with a capacitor (C1) in parallel.

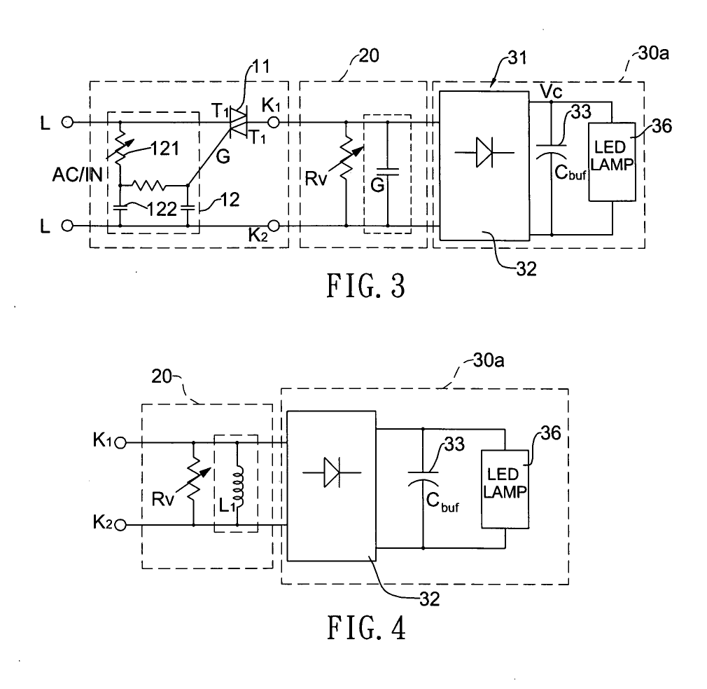

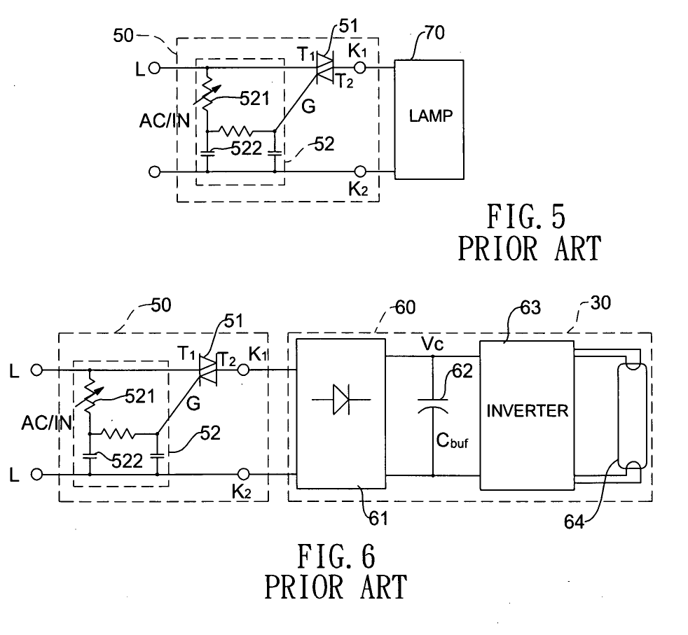

With reference to FIG. 3, the present invention is applied for the non-resistive light-emitting load (30a) of an LED lamp. The LED lamp (36) does not need to use an inverter. Therefore, the light-emitting load (30a) comprises a driving circuit (31) and an LED lamp (36).

The driving circuit (31) has a rectifier (32) and a filter capacitor (33). The rectifier (32) connects to the conductive current sustainer (20). In this embodiment, the rectifier (32) is a full-wave rectifier. The LED lamp (36) consists of several LED elements and is connected to the output terminal of the driving circuit (31).

When the LED lamp is an inductive light-emitting load (30a), the conductive current sustainer (20) has a resistor (R_{V}) and a capacitor (C1) connected with the resistor (R_{V}) in parallel. On the other hand, if the LED lamp is a capacitive light-emitting load (30a), the conductive current sustainer (20) has a resistor (R_{V}) and an inductor (L1) connected with the resistor (R_{V}) in parallel. Therefore, when the disclosed brightness adjuster is connected with a resistor load, the power conversion efficiency is better.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A non-flashing brightness adjusting device for a non-resistive light-emitting load, the non-flashing brightness adjusting device comprising:
a brightness adjuster comprising
an AC silicon-controlled rectifier (SCR) having an anode, a cathode and a gate; and
an adjustable trigger unit connected to the TRIAC to determine a trigger angle of the TRIAC, the trigger angle being proportional to a total output current of the brightness adjuster; and
a conductive current sustainer connected to an output terminal of the brightness adjuster and adapted to connect to a non-resistive light-emitting load, the conductive current sustainer keep a current flowing through the anode and the cathode of the TRIAC, the current being larger than a threshold current, thereby maintaining the conduction of the TRIAC.

2. The non-flashing brightness adjusting device as claimed in claim 1, wherein the conductive current sustainer is a resistor.

3. The non-flashing brightness adjusting device as claimed in claim 1, wherein the conductive current sustainer is a variable resistor.

4. The non-flashing brightness adjusting device as claimed in claim 1, wherein the conductive current sustainer is a positive temperature coefficient resistor.

5. The non-flashing brightness adjusting device as claimed in claim 2, wherein the conductive current sustainer is connected with an inductor in parallel.

6. The non-flashing brightness adjusting device as claimed in claim 3, wherein the conductive current sustainer is connected with an inductor in parallel.

7. The non-flashing brightness adjusting device as claimed in claim 4, wherein the conductive current sustainer is connected with an inductor in parallel.

8. The non-flashing brightness adjusting device as claimed in claim 2, wherein the conductive current sustainer is connected with a capacitor in parallel.

9. The non-flashing brightness adjusting device as claimed in claim 3, wherein the conductive current sustainer is connected with a capacitor in parallel.

10. The non-flashing brightness adjusting device as claimed in claim 4, wherein the conductive current sustainer is connected with a capacitor in parallel.

11. The non-flashing brightness adjusting device as claimed in claim 2, wherein
the adjustable trigger unit is an RC phase-shifting circuit and comprises a variable resistor and a capacitor both connected in series, a node between the variable resistor and the capacitor is connected with the gate of the TRIAC; and the trigger angle of the TRIAC is determined by changing the resistance of the variable resistor.

12. The non-flashing brightness adjusting device as claimed in claim 3, wherein
the adjustable trigger unit is an RC phase-shifting circuit and comprises a variable resistor and a capacitor both connected in series, a node between the variable resistor and the capacitor is connected with the gate of the TRIAC; and the trigger angle of the TRIAC is determined by changing the resistance of the variable resistor.

13. The non-flashing brightness adjusting device as claimed in claim 4, wherein
the adjustable trigger unit is an RC phase-shifting circuit and comprises a variable resistor and a capacitor both connected in series, a node between the variable resistor and the capacitor is connected with the gate of the TRIAC; and the trigger angle of the TRIAC is determined by changing the resistance of the variable resistor.

14. The non-flashing brightness adjusting device as claimed in claim 5, wherein
the adjustable trigger unit is an RC phase-shifting circuit and comprises a variable resistor and a capacitor both connected in series, a node between the variable resistor and the capacitor is connected with the gate of the TRIAC; and the trigger angle of the TRIAC is determined by changing the resistance of the variable resistor.

15. The non-flashing brightness adjusting device as claimed in claim 6, wherein
the adjustable trigger unit is an RC phase-shifting circuit and comprises a variable resistor and a capacitor both connected in series, a node between the variable resistor and the capacitor is connected with the gate of the TRIAC; and the trigger angle of the TRIAC is determined by changing the resistance of the variable resistor.

16. The non-flashing brightness adjusting device as claimed in claim 7, wherein
the adjustable trigger unit is an RC phase-shifting circuit and comprises a variable resistor and a capacitor both connected in series, a node between the variable resistor and the capacitor is connected with the gate of the TRIAC; and the trigger angle of the TRIAC is determined by changing the resistance of the variable resistor.

17. The non-flashing brightness adjusting device as claimed in claim 8, wherein
the adjustable trigger unit is an RC phase-shifting circuit and comprises a variable resistor and a capacitor both connected in series, a node between the variable resistor and the capacitor is connected with the gate of the TRIAC; and the trigger angle of the TRIAC is determined by changing the resistance of the variable resistor.

18. The non-flashing brightness adjusting device as claimed in claim 9, wherein
the adjustable trigger unit is an RC phase-shifting circuit and comprises a variable resistor and a capacitor both connected in series, a node between the variable resistor and the capacitor is connected with the gate of the TRIAC; and the trigger angle of the TRIAC is determined by changing the resistance of the variable resistor.

19. The non-flashing brightness adjusting device as claimed in claim 10, wherein
the adjustable trigger unit is an RC phase-shifting circuit and comprises a variable resistor and a capacitor both connected in series, a node between the variable resistor and the capacitor is connected with the gate of the TRIAC; and the trigger angle of the TRIAC is determined by changing the resistance of the variable resistor.
